(19) United States
(12) Patent Application Publication
(10) Pub. No.: US 2005/0228566 A1
(43) Pub. Date: Oct. 13, 2005

(54) Configuration for generating an activating signal for restraint means and method for activating restraint means in a vehicle

(76) Inventors: Michael Roelleke, Leonberg-Hoefingen (DE); Gerhard Loeckle, Ludwigsburg (DE); Robert Lahmann, Nurnberg (DE); Morten Trachterna, Berlin (DE); Michael Schmid, Kornwestheim (DE); Mario Kroeninger, Buehl (DE); Carsten Lorenz, Sindelfingen (DE); Martin Lanzerath, Denfendorf (DE)

Correspondence Address: KENYON & KENYON, ONE BROADWAY, NEW YORK, NY, 10004, US

(21) Appl. No.: 10/511,969

(22) PCT Filed: Mar. 12, 2003
(86) PCT No.: PCT/DE03/00780

§ 371 Date: May 6, 2005

(30) Foreign Application Priority Data
Apr. 23, 2002 (DE) 102 18 020.2

(51) Int. Cl. G06F 7/00

(52) U.S. Cl. 701/45; 701/301

(57) ABSTRACT

An improved passenger protection is achieved by refining the criterion for triggering the restraining unit provided for impact situations. A system and a method for generating a triggering signal for the restraining unit in a vehicle are provided for this purpose, the restraining unit being provided for the event of a collision of the vehicle—head-on collision, side impact. The system includes a unit for detecting an impact, which, in the event of an impact, generates a request signal for the restraining unit corresponding to the type of impact, and a unit for detecting a rotational motion of the vehicle about at least one vehicle axis—longitudinal axis (x) and/or transverse axis (y)—which generate a corresponding status signal. A circuit is provided for generating a triggering signal, the circuit combining the request signal and the status signal so that the information about the possible occurrence or the existence of a rotational motion is taken into account in the decision about triggering the restraining means.

### FIELD OF THE INVENTION

The present invention relates to a system for generating a triggering signal for restraining means in a vehicle, the restraining means being provided for the event of a collision of the vehicle, such as a head-on collision or a side impact. To that effect, the system includes means for detecting an impact which, in the event of an impact, generate a request signal for the restraining means corresponding to the type of impact. Means for detecting a rotational motion of the vehicle about at least one vehicle axis are additionally provided.

Furthermore, the present invention relates to a method for triggering restraining means which are provided for the event of a collision of the vehicle. In addition to information about a possible collision of the vehicle, information about a possible rotational motion of the vehicle about at least one vehicle axis is collected and analyzed.

### BACKGROUND INFORMATION

In the conventional vehicles which are equipped with restraining means, triggering of the restraining means in accidents involving a head-on collision or a side impact normally takes place independently from the circumstances of the accident. In particular, it is not taken into account in the conventional triggering algorithms whether a rollover takes place or has already taken place during the course of the accident. Due to this fact, the driver airbag and the front passenger airbag may be deployed, for example, even though the vehicle is lying on its roof after a rollover, the passenger compartment has been made smaller by the rollover, and the passengers are situated in an undefined position. If the vehicle lands on its side during a rollover, triggering of the particular side airbag is at least critical when a vehicle passenger is situated directly above the side airbag. Overall, practice has shown that in accidents in the course of which a critical rotational motion of the vehicle occurs in addition to an impact, a not negligible injury risk for the vehicle passengers emanates from triggering the restraining means provided for the impact situation. Protection of the vehicle passengers may be improved in that the circumstances of the accident are taken into account in the decision about triggering the restraining means

### SUMMARY

The present invention improves the passenger protection by refining the criterion for triggering the restraining means provided for impact situations. To this end, information about the possible occurrence or existence of a rotational motion of the vehicle is taken into account in the decision about triggering these restraining means. According to the present invention, this is implemented by using a circuit which, for generating a triggering signal, combines the request signal and the status signal—and thus the information about the circumstances of the accident.

The present invention utilizes the fact that it is reasonable to coordinate the use of all restraining means situated in the vehicle, in particular when the vehicle rolls over during the course of an accident, or when the vehicle experiences a critical rotational motion in which the vehicle topples over on the side, for example. In addition, it is recognized according to the present invention that in such accidents triggering of the restraining means, which are supposed to protect the vehicle passengers during a critical rotational motion of the vehicle such as a rollover, has a higher priority than triggering of the restraining means provided for impact situations. Therefore, the criterion for triggering these restraining means is refined according to the present invention. According to the present invention, information is used for refining the triggering criterion which is collected and analyzed for determining a critical rotational motion of the vehicle since the position and the state of the vehicle, as well as the position of the passengers in the passenger compartment, may be estimated relatively easily using this information. On the basis of this estimation, it may then be better decided whether it is sensible or even detrimental to the protection of the passengers to trigger the restraining means provided for the present impact situation.

In an example embodiment of the present invention, it is provided to block the restraining means in the event of an impact situation for a defined period of time tₛₜₒₚ when a critical rotational motion of the vehicle has been recognized. The circuit of the system according to the present invention includes at least one hold element for this purpose, with which period of time tₛₜₒₚ, in which no triggering signal may be generated, is determined. The circuit and the hold element in particular are designed in such a way that, in the event of a collision, the restraining means are only blocked when additionally a critical rotational motion is also recognized. For this purpose, the information about the possible occurrence or existence of a rotational motion of the vehicle is analyzed based on one or also multiple criteria which may differ from vehicle type to vehicle type and may be predefined by the vehicle manufacturer.

When the vehicle rolls over prior to impact, it is oftentimes reasonable to block or at least to delay triggering of the restraining means. In order to recognize such situations, the vehicle's instantaneous angular position (αₓ and/or α_{y}) is detected and analyzed in an example embodiment of the present invention. Whenever the instantaneous angular position (αₓ and/or α_{y}) exceeds a first appropriately selected threshold value (α_{x min1} and/or α_{y min1}) it is assumed that a rollover is taking place or has taken place, which is recognized as a rotational motion in the context of the present invention.

Furthermore, it may be reasonable to block or at least to delay triggering of the restraining means as soon as a rollover is predicted, i.e., the vehicle has not yet rolled over, but a rollover is imminent. For recognizing such situations it is provided according to the present invention to also detect and analyze the vehicle's instantaneous angular velocity (ωₓ and/or ω_{y}) in addition to the instantaneous angular position (αₓ and/or α_{y}). A rollover may be easily predicted in this case and the existence of a critical rotational motion may thus be assumed when the instantaneous angular position (αₓ and/or α_{y}) exceeds a second appropriately selected threshold value (α_{x min2} and/or α_{y min2}), and when the instantaneous angular velocity (ωₓ and/or ω_{y}) also exceeds an appropriately selected threshold value (ω_{x min} and/or ω_{y min}).

It should be noted at this point that the occurrence of a rollover may be recognized or predicted using other motion parameters which may likewise be detected and analyzed with the help of a system according to the present invention and within the scope of the method according to the present invention. In addition, other or more rotational motions of the vehicle may be defined as being critical.

As already mentioned, the criteria on the basis of which a possible rotational motion of the vehicle is classified as being critical or uncritical may be determined by the vehicle manufacturer for example. In addition, period of time tₛₜₒₚ in which the restraining means are blocked may be determined individually, namely not only dependent on the vehicle type but also dependent on the circumstances of the accident. In the event of an impact, the restraining means may be blocked permanently (tₛₜₒₚ=∞) for example or only for a limited period of time (tₛₜₒₚ=const.) when a critical rotational motion has been recognized.

Oftentimes it is advantageous to block the restraining means at least until the vehicle has come to rest. To determine this, a third threshold value for the instantaneous angular position (αₓ and/or α_{y}) for example may be defined. If the instantaneous angular position (αₓ and/or α_{y}) falls below this third threshold value (α_{x min3} and/or α_{y min3}) it may be assumed that the vehicle has come to rest. Detecting and analyzing the vehicle's instantaneous linear acceleration (aₓ, a_{y} and/or a_{z}) presents another possibility. In this case, for example, it may then be assumed that the vehicle has come to rest when a function of the instantaneous linear acceleration f (aₓ, a_{y} and/or a_{z}) falls below a defined threshold value aₘᵢₙ.

### BRIEF DESCRIPTION OF THE DRAWINGS

FIGS. 1a through 1c each show a block diagram of an example embodiment of a system according to the present invention for generating a triggering signal for restraining means in a vehicle.

FIGS. 2a through 2d each show a block diagram of an example embodiment of the hold element of a system according to the present invention.

### DETAILED DESCRIPTION

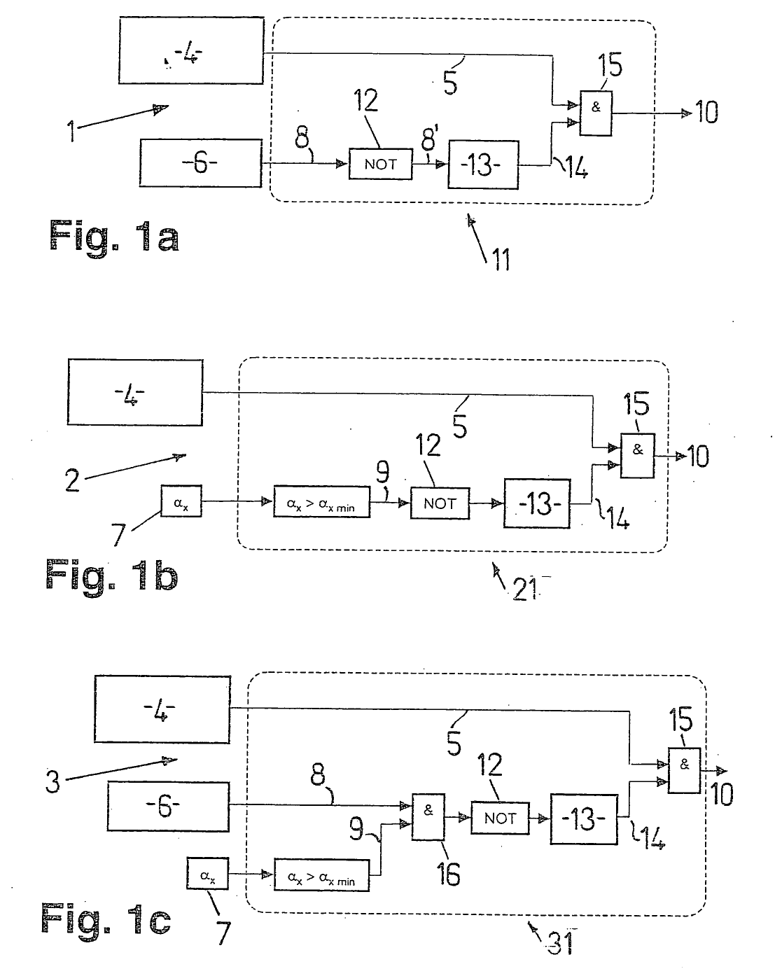

Example systems 1, 2 and 3 according to the present invention described below in connection with FIGS. 1a through 1c are each used for generating a triggering signal for restraining means in a vehicle, the restraining means being provided for the event of a collision of the vehicle, such as a head-on collision or a side impact. All three example systems include means 4 for detecting a collision and which, in the event of an impact, generate a request signal 5 for the restraining means which are appropriately provided for the existing type of impact. In addition, means 6 and/or 7 for detecting a rotational motion of the vehicle about at least one vehicle axis—longitudinal axis (x) and/or transverse axis (y)—are provided in all three embodiments. These means generate a corresponding status signal 8 or 9.

According to the present invention, each of systems 1, 2, or 3 includes a circuit 11, 21, or 31 for generating a triggering signal 10 which combines request signal 5 and status signal 8 and/or 9 so that information about a possible occurrence or the existence of a rotational motion is taken into account in the decision about triggering the restraining means.

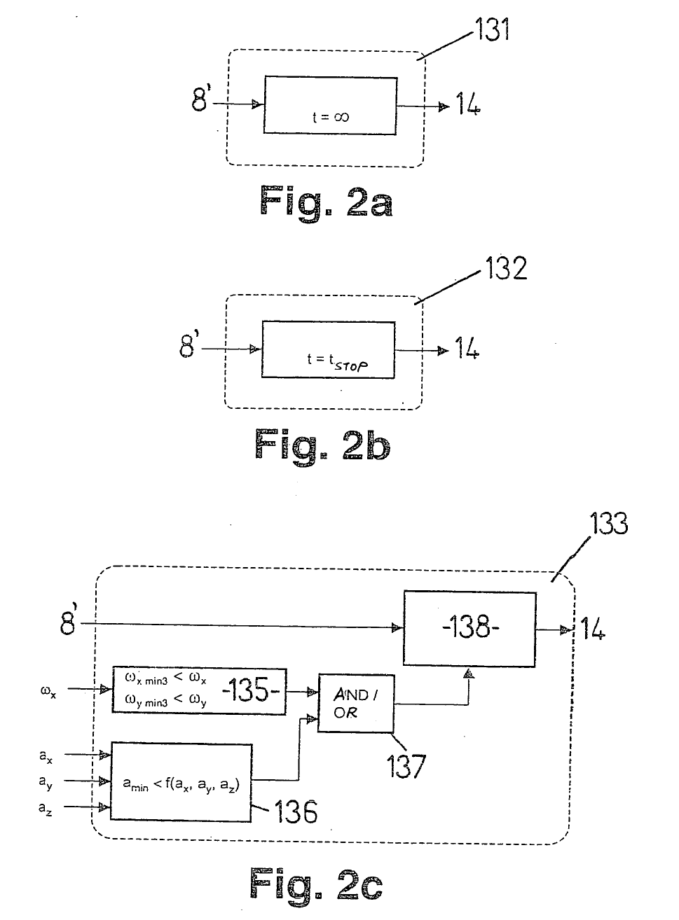

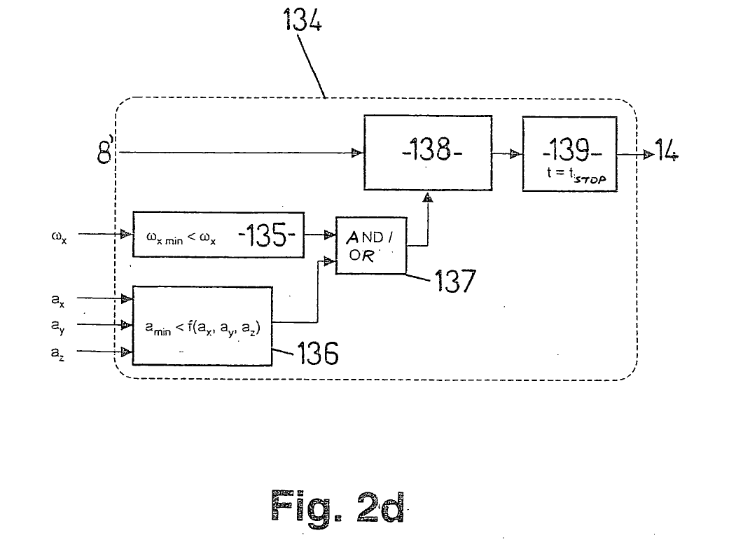

In each of the illustrated exemplary embodiments shown in FIGS. 1a-1c, circuit 11, 21, or 31 includes a hold element 13 whose function only becomes effective when a critical rotational motion has been recognized. In these cases, hold element 13 causes the restraining means to be blocked for a period of time tₛₜₒₚ in the event of an impact. Hold element 13 is designed in such a way that it otherwise does not affect the triggering of the restraining means or the generation of a corresponding triggering signal. The various embodiments for implementing such a hold element 13 are explained in greater detail below in connection with FIGS. 2a through 2d.

In system 1 illustrated in FIG. 1a, means 6 make it possible to predict whether a rollover is to be expected, i.e., whether a vehicle rollover is imminent. Such a prediction may be based, for example, on information about the vehicle's instantaneous angular position (αₓ and/or α_{y}) in connection with information about the vehicle's instantaneous angular velocity (ωₓ and/or ω_{y}) In this case, a rollover is always predicted when the instantaneous angular position (αₓ and/or α_{y}) exceeds a corresponding threshold value (α_{x min2} and/or α_{y min2}) and when the instantaneous angular velocity (ωₓ and/or ω_{y}) also exceeds a corresponding threshold value (ω_{x min} and/or ω_{y min}). Status signal 8 is inverted at unit 12. Inverted status signal 8′ is supplied to the input of hold element 13, the output signal 14 of which is combined with request signal 5 at AND gate 15. Depending on the state of request signal 5 and status signal 8 and depending on the type of hold element 13, a triggering signal 10 for the restraining means is generated as a result of this combination.

During an occurring impact situation, request signal 5 is at logic 1. Normally no rollover is predicted so that status signal 8 is at logic 0 and correspondingly inverted status signal 8′ is at logic 1. As long as no rollover is predicted, hold element 13 transfers the state of inverted status signal 8′ directly to downstream AND gate 15. Since a logic 1 is applied to both inputs of AND gate 15, a triggering signal 10 for the requested restraining means is generated.

If a rollover is predicted during an occurring impact situation, status signal 8 is at logic 1 and correspondingly inverted status signal 8′ is at logic 0. This state is sustained by hold element 13 for a defined period of time tₛₜₒₚ so that logic 1 and logic 0 are applied to AND gate 15. Only after tₛₜₒₚ has elapsed is the then applied instantaneous inverted status signal 8′ which, as mentioned, is normally at logic 1, supplied to AND gate 15. Accordingly, only after expiration of tₛₜₒₚ is a triggering signal 10 generated for the requested restraining means.

In system 2 illustrated in FIG. 1b, triggering of the restraining means at a collision of the vehicle should only be blocked or delayed when a rollover actually occurs, which is determined using means 7. The vehicle's instantaneous angular position (αₓ and/or αy) is monitored for this purpose and compared with a corresponding threshold value (α_{x min2} and/or α_{y min2}). The existence of a rollover situation is assumed when the instantaneous angular position (αₓ and/or α_{y}) exceeds this threshold value (α_{x min2} and/or α_{y min2}) and status signal 9 is set to 1. Otherwise the system illustrated in FIG. 1b is identical to the system illustrated in FIG. 1a.

Means 6 described in connection with FIG. 1a, which allow the prediction of a rollover, and means 7 for detecting a rollover described in connection with FIG. 1b, are combined in system 3 illustrated in FIG. 1c, so that the function of hold element 13 only becomes effective when a rollover is predicted and when instantaneous angular position (αₓ and/or α_{y}) exceeds a certain threshold value (α_{x min2} and/or α_{y min2}). Both status signals 8 and 9 are supplied to an AND gate 16 whose inverted output signal then forms the input signal for hold element 13. Otherwise the system illustrated in FIG. 1c is identical to the systems illustrated in FIGS. 1a and 1b.

It should be noted at this point that the threshold values for the angular positions α_{x min1} and/or α_{y min1} and α_{x min2} and/or α_{y min2} and the threshold value for the angular velocity ω_{x min} and/or ω_{y min} may not only be determined for each space direction x and y, but also individually for each restraining means. Due to this fact it may be achieved, for example, that triggering of the restraining means in head-on accidents is only blocked when the vehicle has rotated about its x-axis or y-axis by at least 180 degrees. It may be assumed in these cases that the roof has been pushed in and the passenger compartment has become smaller. In contrast, the restraining means assigned to a side impact should be blocked as soon as the vehicle has rotated about its x-axis by at least 90 degrees. The passengers are normally in an unfavorable position in this case so that triggering of a side airbag represents an additional injury risk.

As mentioned earlier, different embodiments 131, 132, 133, and 134 for implementing a hold element are illustrated in FIGS. 2a through 2d.

In the embodiment illustrated in FIG. 2a, hold element 131 causes a permanent block (tₛₜₒₚ=∞) of the restraining means assigned to the particular impact situation when a critical rotational motion of the vehicle has been recognized.

In the embodiment illustrated in FIG. 2b, the restraining means assigned to the particular impact situation are only blocked for a limited, defined period of time (tₛₜₒₚ=const.) when a critical rotational motion of the vehicle has been recognized.

In the embodiments illustrated in FIGS. 2c and 2d, the restraining means are blocked in the event of an impact at least until the vehicle has come to rest after a critical rotational motion was detected. In order to detect whether the vehicle has come to rest, the roll angular velocity ωₓ or the pitch angular velocity ω_{y} and the vehicle's three linear accelerations aₓ, a_{y}, and a_{z} are monitored. Using hold element 133 or 134, it is monitored at unit 135 whether the angular velocities ωₓ and ω_{y} fall below a correspondingly defined threshold value ω_{x min3} or ω_{y min3} and it is monitored at unit 136 whether a function f (aₓ, a_{y}, a_{z}) falls below a threshold value aₘᵢₙ. This function f (aₓ, a_{y}, a_{z}) may be implemented, for example, as f (aₓ, a_{y}, a_{z})=|aₓ|+|a_{y}|+|a_{y}|+|a_{z}| or as f (aₓ, a_{y}, a_{z})=max. (|aₓ|, |a_{y}|, |a_{z}|). If one of these two conditions or both conditions are met it is assumed that the vehicle has come to rest. The combination of the respective signals is implemented here using an AND/OR gate 137. The output signal of this AND/OR gate is supplied to a first hold component 138. In the case of the embodiment illustrated in FIG. 2c, hold component 138 cancels the block of the restraining means when the vehicle has come to rest. In the case of the embodiment illustrated in FIG. 2d, the block of the restraining means is sustained over an additional defined period of time t, even when the vehicle has already come to rest. A second hold component 139 downstream from first hold component 138 is provided for this purpose.

1-16. (canceled)

17. A system for generating a triggering signal for a restraining unit in a vehicle, the restraining unit provided for the event of a collision of the vehicle, comprising:
an impact detection unit for detecting an impact of the vehicle, wherein, in the event of an impact, the impact detection unit generates a request signal for the restraining unit, the request signal corresponding to a type of impact that has been detected;
a rotation detection unit for detecting a rotational motion of the vehicle about at least one of the longitudinal axis and the transverse axis of the vehicle, wherein the rotation detection unit generates a status signal corresponding to a rotational motion status; and
a circuit for generating the triggering signal for the restraining unit, wherein the circuit combines the request signal and the status signal in generating the triggering signal, whereby information regarding one of a possible occurrence and the existence of a rotational motion is considered in triggering the restraining unit.

18. The system as recited in claim 17, wherein the circuit includes at least one hold element for determining a period of time during which no triggering signal may be generated when a critical rotational motion of the vehicle has been detected.

19. The system as recited in claim 18, wherein the rotation detection unit includes an arrangement for detecting an instantaneous angular position, and wherein a critical rotational motion of the vehicle is deemed to exist when the instantaneous angular position exceeds a first defined threshold value.

20. The system as recited in 19, wherein the rotation detection unit further includes an arrangement for predicting a rollover, and wherein a critical rotational motion of the vehicle is deemed to exist when a rollover is predicted.

21. The system as recited in claim 20, wherein the arrangement for predicting a rollover is configured to detect and analyze an instantaneous angular velocity of the vehicle, and wherein a rollover is predicted when the instantaneous angular velocity exceeds a second threshold value.

22. The system as recited in claim 21, wherein the hold element determines the period of time tₛₜₒₚ as infinite, whereby the restraining unit is permanently blocked from being triggered.

23. The system as recited in claim 21, wherein the hold element determines the period of time tₛₜₒₚ in such a way that the restraining unit is blocked from being triggered at least until the vehicle has come to rest.

24. The system as recited in claim 23, further comprising:
an arrangement for detecting and analyzing the linear acceleration of the vehicle, in order to determine whether the vehicle has come to rest.

25. A method for triggering a restraining unit in a vehicle, the restraining unit being provided for the event of a collision of the vehicle, comprising:
detecting an impact of the vehicle, wherein, in the event of an impact, a request signal for the restraining unit is generated, the request signal corresponding to a type of impact that has been detected;
detecting one of a possible occurrence of a rotational motion and an existence of a rotational motion of the vehicle; and
generating the triggering signal for the restraining unit, wherein the request signal and information regarding one of the possible occurrence of a rotational motion and the existence of a rotational motion are considered in generating the triggering signal.

26. The method as recited in claim 25, wherein the information regarding one of the possible occurrence of a rotational motion and the existence of a rotational motion of the vehicle is analyzed to determine whether a critical rotational motion exists, and wherein, in the event of an impact, the restraining unit is blocked from being triggered for a selected period of time tₛₜₒₚ when a critical rotational motion exists.

27. The method as recited in claim 26, wherein an instantaneous angular position of the vehicle is detected and analyzed, and wherein a vehicle motion is deemed to be a critical rotational motion when the instantaneous angular position exceeds a first threshold value.

28. The method as recited in claim 27, wherein an instantaneous angular velocity of the vehicle is detected and analyzed, and wherein a vehicle motion is deemed to be a critical rotational motion when the instantaneous angular velocity exceeds a second threshold value.

29. The method as recited in claim 26, wherein, in the event of an impact, the restraining unit is permanently blocked from being triggered when a critical rotational motion has been detected.

30. The method as recited in claim 27, wherein, in the event of an impact, the restraining unit is permanently blocked from being triggered when a critical rotational motion has been detected.

31. The method as recited in claim 28, wherein, in the event of an impact, the restraining unit is permanently blocked from being triggered when a critical rotational motion has been detected.

32. The method as recited in claim 26, wherein, in the event of an impact, the restraining unit is blocked from being triggered at least until the vehicle has come to rest when a critical rotational motion has been detected.

33. The method as recited in claim 27, wherein, in the event of an impact, the restraining unit is blocked from being triggered at least until the vehicle has come to rest when a critical rotational motion has been detected.

34. The method as recited in claim 28, wherein, in the event of an impact, the restraining unit is blocked from being triggered at least until the vehicle has come to rest when a critical rotational motion has been detected.

35. The method as recited in claim 33, wherein the vehicle is deemed to have come to rest when the instantaneous angular position falls below a third defined threshold value.

36. The method as recited in claim 32, wherein an instantaneous linear acceleration of the vehicle is detected, and wherein the vehicle is deemed to have come to rest when a value derived from the instantaneous linear acceleration falls below a defined threshold value for the linear acceleration.
